(19) United States
(12) Patent Application Publication
(10) Pub. No.: US 2007/0143225 A1
(43) Pub. Date: Jun. 21, 2007

(54) Method and system for authorizing automated teller machine access

(76) Inventors: Andrew Robert Hamilton, Dundee (GB); Stephen Neil MacPhail, Dundee (GB); Wolf-Dieter Rossmann, Forfar (GB)

Correspondence Address: JAMES M. STOVER;NCR CORPORATION, 1700 SOUTH PATTERSON BLVD, WHQ4, DAYTON, OH, 45479, US

(21) Appl. No.: 11/300,823

(22) Filed: Dec. 15, 2005

(51) Int. Cl. G06Q 99/00

(52) U.S. Cl. 705/64

(57) ABSTRACT

The invention features a method for authorizing access to an ATM. An ATM receives from a user first biometric information and a first identifier corresponding to at least the user. The ATM transmits the first identifier to a first computer outside the ATM. The first computer reads second biometric information from storage based at least in part on the first identifier. The first biometric information with the second biometric information are compared to generate comparison information. The ATM then authorizes user access to financial transactions based at least in part on the comparison information.

### BACKGROUND

Automated teller machines (sometimes abbreviated as ATMs) can be configured to allow users to perform various financial transactions at any time of day. For example, many banks have one or more ATMs from which users may withdraw cash from a checking or savings account that corresponds to a card provided by the user. ATMs can also include devices called financial self-service terminals and kiosks. ATMs can perform one or more of a large number of customer transactions in addition to simply withdrawing cash such as depositing cash or checks in an account, checking the balance in an account, and transferring funds between accounts.

A bank or other organization that operates an ATM may desire to limit the users who can perform particular transactions. For example, account holders are the only ones intended to perform cash withdrawal transactions from their account. In order to limit the types of transactions that a particular user can perform, many conventional ATMs require users to establish their identity in two ways. First, a user must insert or swipe a card with a magnetic strip that encodes information corresponding to the user using variations in magnetism. Second, the user must enter a particular code, often called an Personal Identification Number or PIN, that also corresponds to the user. If the magnetically-encoded information and PIN match, then the user is allowed to conduct appropriate transactions.

ATM operators that rely on card-encoded information and PINs to identify users may experience use of their ATMs by unauthorized persons who have obtained the card, perhaps by theft, and PIN, perhaps by spying, of the authorized user. Neither of these approaches to authorization require that the authorized person be present.

### SUMMARY

In general, in one aspect, the invention features a method for authorizing access to an ATM. An ATM receives from a user first biometric information and a first identifier corresponding to at least the user. The ATM transmits the first identifier to a first computer outside the ATM. The first computer reads second biometric information from storage based at least in part on the first identifier. The first biometric information with the second biometric information are compared to generate comparison information. The ATM then authorizes user access to financial transactions based at least in part on the comparison information.

In general, in another aspect, the invention features a system for authorizing access to an ATM. The system includes an ATM capable of receiving from a user first biometric information and a first identifier, both corresponding to at least the user. The system also includes a communications link coupled to the ATM and a computer outside the ATM. The computer is also coupled to an electronic storage that includes second biometric information. The computer is configured to read the second biometric information based at least in part on the first identifier. The ATM is configured to authorize access to financial transactions based at least in part on a comparison of the first biometric information and the second biometric information.

In general, in another aspect, the invention features software for administering an ATM. The software includes instructions that cause an ATM to accept from a user first biometric information and a first identifier corresponding to at least the user. The ATM transmits the first identifier to a first computer outside the ATM. The first computer reads second biometric information from storage based at least in part on the first identifier. The first biometric information with the second biometric information are compared to generate comparison information. The ATM then authorizes user access to financial transactions based at least in part on the comparison information.

### BRIEF DESCRIPTION OF THE DRAWINGS

FIG. 1 is a diagram of a system for authorizing access to one or more ATMs according to one exemplary embodiment.

FIG. 2 is a diagram of a system for authorizing access to one or more ATMs according to one exemplary embodiment.

FIG. 3 is a data diagram for an identifier transmission from an ATM to an outside computer according to one exemplary embodiment.

FIG. 4 is a flow chart of a method for administering authorizing access to an ATM according to one exemplary embodiment.

### DETAILED DESCRIPTION

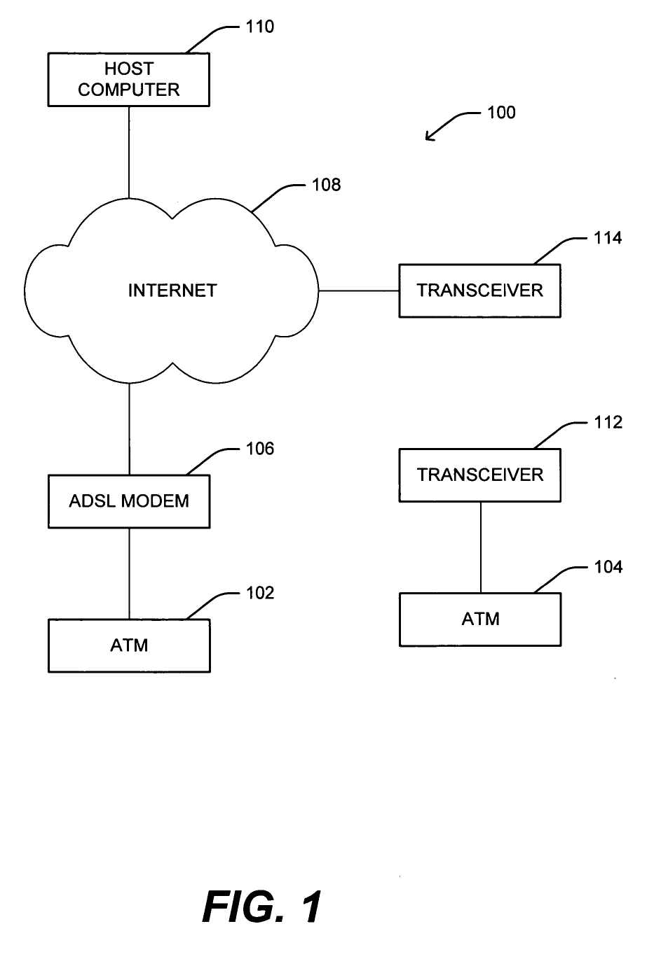

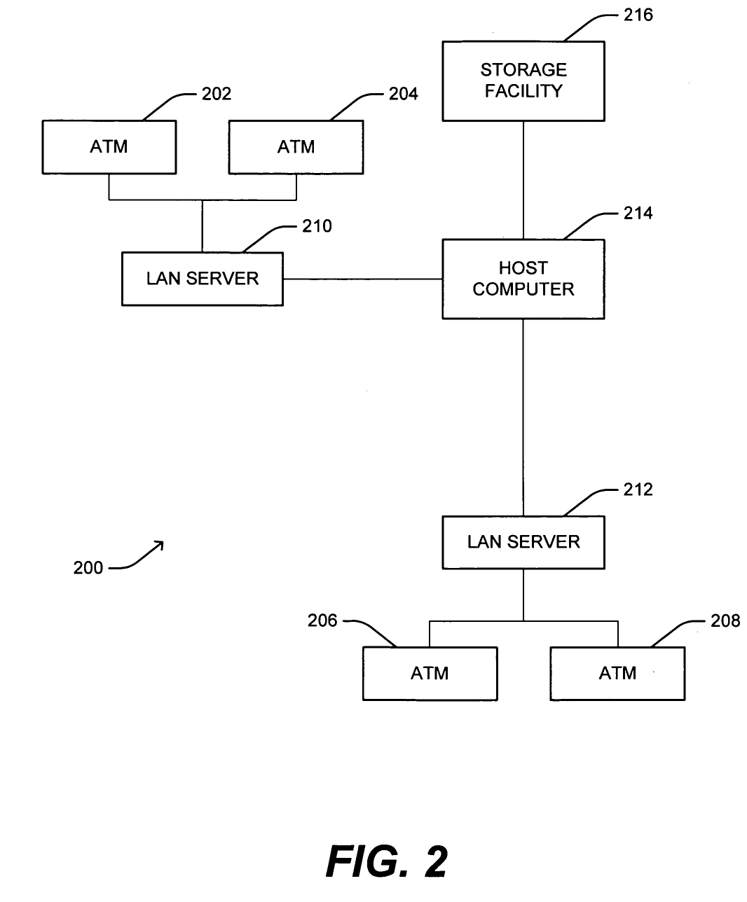

The ATM authorization technique disclosed herein has particular application, but is not limited, to groups of ATMs that are networked together for central administration. FIGS. 1 and 2 illustrate different embodiments of system configurations for operating ATMs in a manner that provides security through authorization of financial transactions. Those systems are exemplary and many different systems can be utilized with various communications technologies.

In FIG. 1, the system 100 includes two ATMs 102, 104, each with a communications link to a host computer 110 that is located outside the ATMs 102, 104. In the FIG. 1 embodiment, the host computer is coupled to the Internet 108. ATM 102 communicates with a computer in the Internet 108 over an Asymmetric Digital Subscriber Line (ADSL) using an ADSL modem 106. ATM 104 communicates with a computer in the Internet 108 over a wireless connection established by two transceivers 112, 114 that exchange electromagnetic waves that are modified in a predetermined manner to indicate information. While ATMs 102, 104 may have different data transfer rates, each is coupled to the host computer 110 through a communications link that includes the Internet 108.

In FIG. 2, the system 200 includes four ATMs 202, 204, 206, 208 which are organized into two groups of two. Each group of ATMs is associated with a LAN server 210, 212 (LAN is an acronym for Local Area Network) that is located outside the ATMS. System 200 can be used when multiple ATMs are associated with particular physical locations. For example, a bank or a shopping mall may have two or more ATMs. The first group of ATMs 202, 204 are coupled to LAN server 210. As one example, the ATMs 202, 204 can use an ethernet protocol (such as Ethernet, 100Base-T, or Gigabit Ethernet) and architecture to route messages to and from the LAN server 210. Other LAN protocols and architectures can also be used. The second group of ATMs 206, 208 are couple to LAN server 212. The LAN servers 210, 212 are coupled to the host computer 214 that is also outside the ATMs, for example in a Wide Area Network (WAN). The communications between the LAN servers 210, 212 and the host computer 214 can travel through a public network such as the telephone system or the Internet. The communications between the LAN servers 210, 212 and the host computer 214 can also travel through private telecommunications devices such as a leased line or a satellite. While system 200 shows only two LAN servers 210, 212, additional LANs with two or more ATMs could be added. For example, a banking company may have hundreds of branches with each branch including one or more ATMs that are connected to a LAN for that branch. A LAN server employed with a particular bank branch can be called a branch controller. The LAN need not be dedicated to the ATMs. For example, computers used by branch employees may also be connected to the LAN and the WAN to send and receive information. As an alternative embodiment, the ATMs 202, 204 may only send information to the LAN server 210 and not to the host computer 214. An employee of the branch with LAN server 210 can then determine whether to send a group of ATM communications on to the host computer 214 or an automatic process can be performed, for example at the end of the day. A storage facility 216 can also be provided to store biometric information as discussed below.

While FIGS. 1 and 2 illustrate particular network configurations, many other configurations are possible. For example, a single ATM may communicate with a single computer outside that ATM through a dial-up link. In other words, the ATM establishes a call only as part of the process for sending a message and does not maintain the call at other times. Such a call can occur over a copper wire connection or using a wireless connection established by a mobile phone as two examples. In addition, many different communications protocols can be used to encode information transmitted from the ATM(s), including but not limited to Transmission Control Protocol/Internet Protocol (TCP/IP), Synchronous Optical NETwork (SONET), and Code Division Multiple Access (CDMA). The information transmitted using these protocols can be compressed prior to transmission using, for example, one of several known compression techniques. The communications hardware includes but not limited to electrical wires or cables, optical cables, and wireless transmitters and receivers.

In one embodiment, the ATMs shown in FIGS. 1 and 2 are accessible by customers for customer transactions. The ATM operator can enroll potential customers and have biometric information synthesized into a template. That template could then be the source of biometric information stored at a computer outside the ATM. The ATMs can include buttons, a card scanner, or a touch-sensitive screen by which the ATM receive instructions and information from a customer. The ATM can also include a scanner for receiving biometric information from the customer. One example ATM may have a magnetic scanner, a screen, a group of number keys, a group of buttons next to the screen, and an iris scanner. The ATM is programmed to have a transaction ready state where a customer can initiate a transaction by inserting a card with a magnetic strip into the magnetic scanner. The ATM can read the magnetic strip to determine what information is on the card. The ATM can then display a request for a code to be entered using the number keys. The ATM can then wait a predetermined amount of time to receive the code.

Instead of or in addition to the code, the ATM can display a request that the user place her eye proximate the iris scanner. The iris scanner would then scan light across the iris and measure the reflected light to generate first biometric information.

In one embodiment, identification information read off the magnetic card and the first biometric information are encrypted and then packaged in a file formatted in eXensible Markup Language (XML). For example, symmetric key encryption can be used to encrypt the information. The message is then sent to the host computer, which is outside of the ATM. The message can be further protected by a message authentication algorithm. When the host computer receives the message, it can match the identification information to similar information in a table and read second biometric information stored in association. The host computer can then compare the first and second biometric information. Such a comparison can include determining similarities, determining differences, or doing both. The comparison process generates information that indicates how close a match was found. For example, the comparison information can be a match probability, which reflects the percentage likelihood that the first biometric information belongs to the same person as the second biometric information. The ATM operator can establish match probability requirements for determining whether the result of a particular comparison is sufficiently close to authorize financial transactions. For example, an operator could require that the match probability indicates at least a 99% chance that the scanned biometric information belongs to the same person as the stored biometric information before the host computer send an authorization message to the ATM. The ATM responds to an authorization message by allowing the user to conduct financial transactions.

In another embodiment, identification information read off the magnetic card is encrypted and then packaged in a XML-formatted file. The message is then sent to the host computer. When the host computer receives the message, it can match the identification information to similar information in a table and read second biometric information stored in association. The host computer can then send the second biometric information back to the ATM. For example, the second biometric information could be encrypted and then packaged in a XML-formatted file for transmission. The ATM can compare the biometric information after receiving the message. Such a comparison can include determining similarities, determining differences, or doing both. As discussed above, the ATM operator can establish match probability requirements for determining whether the result of a particular comparison is sufficiently close to authorize financial transactions. In another embodiment, the account holder can establish the match requirements when submitting the biometric information to be stored at the host computer. If the comparison outcome meets or exceeds the requirements, the ATM allows the user to conduct financial transactions.

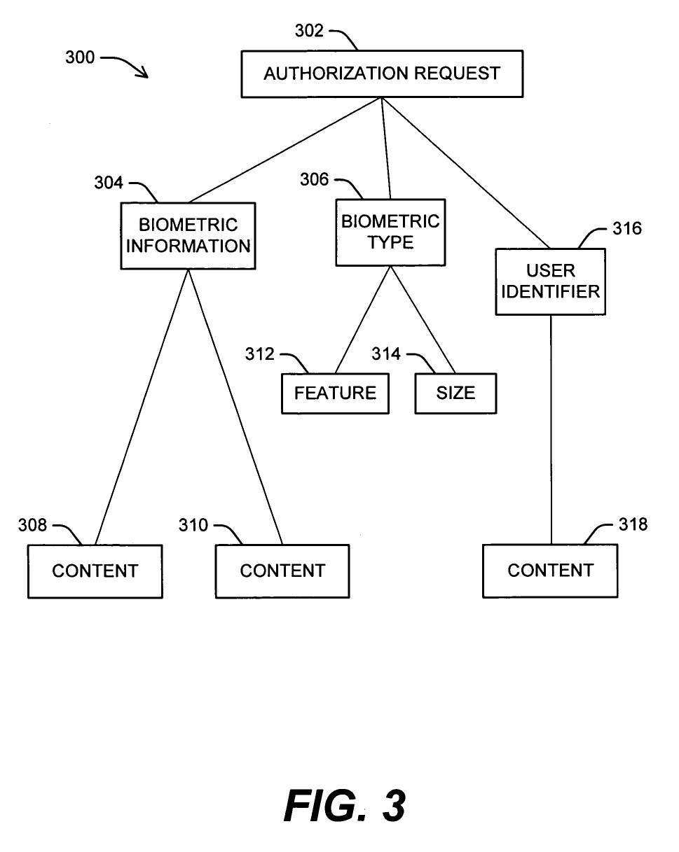

FIG. 3 illustrates the data structure 300 of an example message sent in XML format as part of one embodiment of the method for authorizing access. The message information is stored in nested tags. Each of the tags can include data and/or tags contained within it. The top level tag is the AuthorizationRequest tag 302. The BiometricInformation tag 302 and the BiometricType tag 306 work together to provide the computer outside the ATM with sufficient biometric information. In this embodiment, the BiometricType tag 306 include a Feature tag 312 that indicates what type of biometric information is being transmitted. As one example, the Feature tag 312 can have include a value of 1 to indicate an iris scan, 2 to indicate a finger print, 3 to indicate facial structure, 4 to indicate a voice sample, and 5 to indicate a writing sample. The Size tag 314 indicates the amount of biometric information, e.g. 400 bytes. The BiometricInformation tag 304 includes two Content tags 308, 310 that contain the actual measurements of the biometric feature. As one example, Content tag 308 could contain the scan measurements for the right iris and the Content tag 310 could contain the scan measurements of the left iris. The UserIdentifier tag 304 includes a Content tag 318 that stores the user identifier corresponding to the stored biometric information at the outside computer. In this embodiment, the outside computer could have access to both fingerprint and iris scan information for each user identifier and will make the comparison based on the content of the Feature tag 312. The data structure of FIG. 3 is just one possible format of a message file that can be sent from the ATM to the outside computer.

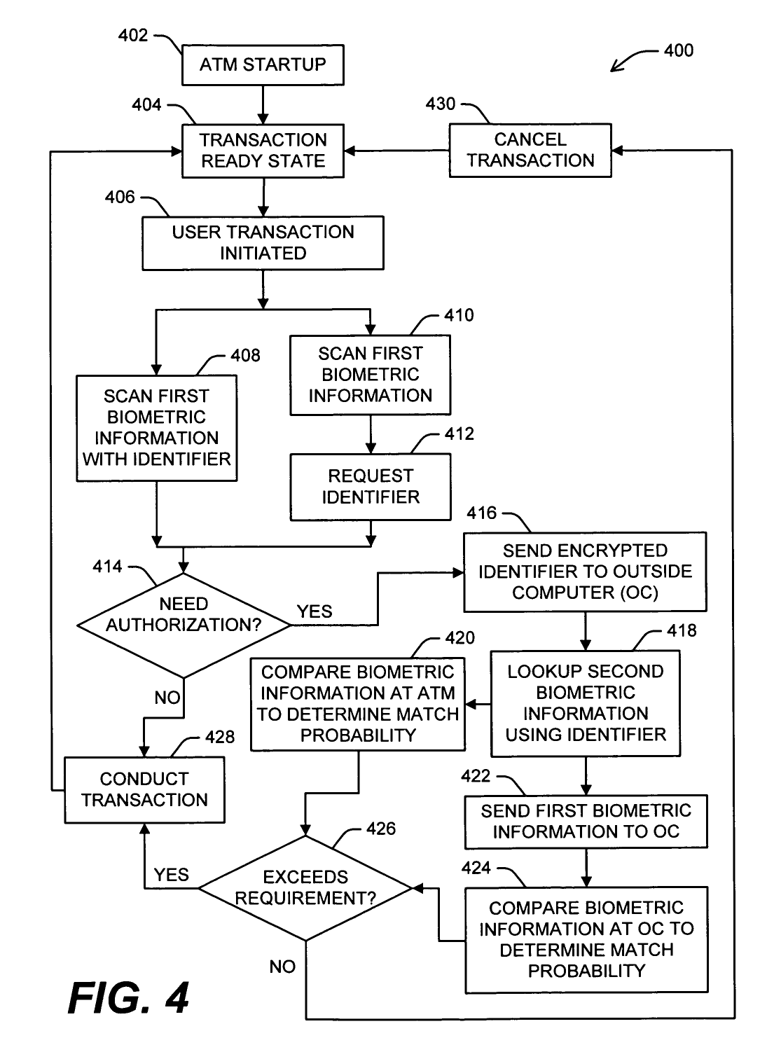

FIG. 4 is a flow chart of a method for authorizing access to an ATM according to one exemplary embodiment. The method begins with ATM startup 402, during which the ATM's hardware and software prepares for operation. The ATM then enters a state in which it is ready to conduct transactions 404. For example, the ATM may display a message on its screen stating “insert card to begin.” The ATM can then be used to initiate a customer transaction 406. Two different exemplary embodiments are then illustrated.

In the first embodiment, the ATM scans first biometric information with an identifier 408. The identifier can be with the biometric information when it is derivable therefrom. For example, the ATM may scan the user's hand writing of her account number. The measurements of the hand written sample could then be the first biometric information. An algorithm could be applied to the sample to derive the account number and that account number can be the user identifier. By receiving the hand-written account number, the ATM would receive both the first biometric information and the user identifier. Another example of biometric information from which an identifier can be derived is a voice scan of the user speaking her account number.

In the second embodiment, the ATM scans first biometric information 410. For example, the ATM may scan an iris or a vein pattern or a voice pattern. The ATM also requests the user identifier 412. The user identifier can be entered before or after the first biometric information. For example, a user could enter a card with magnetic encoding that includes the identifier and then provide the first biometric information. As additional examples, the identifier can be typed into the ATM or can be derived from a passbook.

In the illustrated embodiment, once the user provides the identifier and the first biometric information, the ATM determines whether authorization is needed 414. An ATM operator or account holder can decide that certain transactions, e.g., deposits, do not require authorization. If authorization is not required, then the transaction is conducted 428. Alternatively, the decision 414 can be made prior to the scanning of biometric information 408, 410. If authorization is required 414, the identifier is encrypted and sent to a computer outside the ATM 416. Second biometric information is then looked up based on the identifier 418. As an example, biometric information can be stored in a database table with each row containing biometric information and the identifier corresponding to it. Using the identifier, the outside computer can locate the row and read the biometric information from that row.

Once the second biometric information is available, two embodiments are illustrated. First, the second biometric information can be compared with the first biometric information at the ATM 420. Second, the first biometric information can be sent to the outside computer 422 and compared with the second biometric information 424. In either case, the comparison yields comparison information, e.g. a match probability, that is compared to a requirement 426. If the requirement is met, the transaction is conducted 428. If not, the transaction is cancelled 430. In an alternative embodiment, the comparison information indicates the differences between the biometric information and the requirement is a maximum such that the test is whether the match probability is less than the requirement.

In an alternative embodiment, the identifier is not unique. For example, a customer's name can be used as the identifier and may be the same as that of another customer. In this case, multiple comparisons will occur. Each comparison will be between the first biometric information and second biometric information that is read based at least in part on the identifier. An authorization can then occur if one biometric matches significantly better than the others.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for authorizing access to an Automated Teller Machine (ATM), comprising:
receiving at an ATM from a user first biometric information and a first identifier, both corresponding to at least the user;
transmitting the first biometric information and the first identifier to a first computer outside the ATM;
reading, using the first computer, second biometric information from storage based at least in part on the first identifier;
comparing, using the first computer, the first biometric information with the second biometric information to generate comparison information; and
authorizing user access to financial transaction on the ATM based at least in part on the comparison information.

2. The method of claim 1, wherein the first identifier and first and second biometric information all correspond to the user.

3. The method of claim 1, wherein the step of comparing includes determining the differences between the first biometric information and the second biometric information.

4. The method of claim 1, further comprising the step of encrypting the first identifier prior to transmitting it.

5. The method of claim 1, further comprising the step of encrypting the first biometric information prior to transmitting it.

6. The method of claim 1, wherein the step of comparing includes determining the similarities between the first biometric information and the second biometric information.

7. The method of claim 1, wherein the comparison information is a match probability.

8. The method of claim 1, wherein the first identifier is derived from the biometric information.

9. The method of claim 1, wherein the step of receiving first biometric information includes the step of scanning a physical feature of the user to determine the first biometric information.

10. A system for authorizing access to an Automated Teller Machine (ATM), comprising:
an ATM configured to receive from a user first biometric information and a first identifier, both corresponding to at least the user;
a communication link coupled to the ATM;
a computer outside the ATM that is coupled to the communication link; and
an electronic storage coupled to the computer that includes second biometric information,
wherein the computer is configured to read the second biometric information based at least in part on the first identifier and compare the first biometric information with the second biometric information to generate comparison information; and
wherein the ATM is configured to transmit the first biometric information and a first identifier to the computer over the communication link and authorize access to financial transactions based at least in part on the comparison information.

11. The system of claim 10, wherein the first identifier and first and second biometric information all correspond to the user.

12. The system of claim 10, wherein the comparison information corresponds to differences between the first biometric information and the second biometric information.

13. The system of claim 10, wherein the ATM includes an encryption program and is configured to encrypt the first identifier.

14. The system of claim 10, wherein the ATM includes an encryption program and is configured to encrypt the first biometric information.

15. The system of claim 10, wherein the comparison information corresponds to similarities between the first biometric information and the second biometric information.

16. The system of claim 10, wherein the first identifier is derived from the biometric information.

17. The system of claim 10, wherein the ATM is configured to receive the first biometric information by scanning a physical feature of the user.

18. Computer software, stored on a tangible storage medium, for authorizing access to an Automated Teller Machine (ATM), the software comprising executable instructions that cause at least one computer to:
receive at an ATM from a user first biometric information and a first identifier, both corresponding to at least the user;
transmit the first biometric information and the first identifier to a first computer outside the ATM;
read, using the first computer, second biometric information from storage based at least in part on the first identifier;
compare, using the first computer, the first biometric information with the second biometric information to generate comparison information; and
authorize user access to financial transactions on the ATM based at least in part on the comparison information.

19. The software of claim 18, wherein the first identifier and first and second biometric information all correspond to the user.

20. The software of claim 18, wherein the computer compares by determining the differences between the first biometric information and the second biometric information.

21. The software of claim 18, further comprising executable instructions that cause the ATM to encrypt the first identifier prior to transmitting it.

22. The software of claim 18, further comprising executable instructions that cause the ATM to encrypt the first biometric information prior to transmitting it.

23. The software of claim 18, wherein the computer compares by determining the similarities between the first biometric information and the second biometric information.

24. The software of claim 18, wherein the comparison information is a match probability.

25. The software of claim 18, wherein the first identifier is derived from the biometric information.

26. The software of claim 18, wherein the ATM receives the first biometric information by scanning a physical feature of the user to determine the first biometric information.
